(19) United States
(12) Patent Application Publication
(10) Pub. No.: US 2023/0120775 A1
(43) Pub. Date: Apr. 20, 2023

(54) APPARATUS AND METHOD FOR REDUCING DEFECTS IN GLASS MELT SYSTEMS

(71) Applicant: Corning Incorporated, Corning, NY (US)

(72) Inventors: Martin Herbert Goller, Campbell, NY (US); Matthew Carl Morse, Horseheads, NY (US)

(21) Appl. No.: 17/905,853

(22) PCT Filed: Mar. 17, 2021
(86) PCT No.: PCT/US2021/022695

§ 371 Date: Sep. 8, 2022

Related U.S. Application Data
(60) Provisional application No. 63/001,811, filed on Mar. 30, 2020.

(51) Int. Cl. C03B 7/00; C03B 7/092

(52) U.S. Cl. CPC C03B 7/005; C03B 7/092

(57) ABSTRACT

An apparatus and method for manufacturing a glass article includes a conduit of precious metal or precious metal alloy hat encloses molten glass. The apparatus and method also includes a channel positioned inside or proximate the conduit that flows a defect inhibiting fluid therethrough. The channel includes at least one orifice positioned proximate a free surface of the molten glass from which flows the defect inhibiting fluid.

This application claims the benefit of priority under 35 U.S.C. § 119 of U.S. Provisional Application Ser. No. 63/001,811, filed on Mar. 30, 2020, the content of which is relied upon and incorporated herein by reference in its entirety.

### FIELD

The present disclosure relates generally to glass melting systems and particularly to apparatuses and methods for reducing defects in glass melting systems.

### BACKGROUND

In the production of glass articles, such as glass sheets for display applications, including televisions and hand-held devices, such as telephones and tablets, molten glass is transported through a glass melting system. The glass melting system typically includes vessels or conduits comprising a precious metal or precious metal alloy, wherein molten glass is transported through the vessels or conduits, physically contacting the precious metal or precious metal alloy. Such contact between the molten glass and the precious metal or precious metal alloy can lead to chemical reactions, such a redox reactions, wherein a precious metal or precious metal oxide is transported into the molten glass or on the molten glass surface. The presence of such precious metal or precious metal oxide in the molten glass or on the molten glass surface can result in undesirable defects in the glass articles. In addition, such reactions can result in corrosion of the vessels or conduits of the glass melting system, which can, in turn, result in the need to repair or replace such components as well as undesirable process down time. Accordingly, it would be desirable to mitigate or inhibit these effects.

### SUMMARY

Embodiments disclosed herein include an apparatus for manufacturing a glass article. The apparatus includes a conduit comprising a precious metal or precious metal alloy and configured to flow molten glass therethrough. The apparatus also includes a channel positioned inside or proximate the conduit and configured to flow a defect inhibiting fluid therethrough. The channel includes at least one orifice configured to be positioned proximate a free surface of the molten glass and to flow the defect inhibiting fluid out of the channel.

Embodiments disclosed herein also include a method of manufacturing a glass article. The method includes transporting molten glass through a conduit comprising a precious metal or precious metal alloy. The method also includes flowing a defect inhibiting fluid out of at least one orifice of a channel positioned inside or proximate the conduit. The at least one orifice is positioned proximate a free surface of the molten glass.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic side cutaway view of a portion of an example mixing vessel in accordance with embodiments disclosed herein;

FIG. 3 is schematic top cutaway view of the example mixing vessel of FIG. 2;

FIG. 4 is schematic side cutaway view of a portion of an example mixing vessel in accordance with embodiments disclosed herein;

FIG. 5 is a schematic top cutaway view of the example mixing vessel of FIG. 4;

FIG. 6 is a schematic side cutaway view of a portion of an example conduit in accordance with embodiments disclosed herein; and

FIG. 7 is a schematic side cutaway view of a portion of an example conduit in accordance with embodiments disclosed herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “proximate” refers to a distance of less than or equal to about 75 millimeters.

As used herein, the term “defect inhibiting fluid” refers to a fluid that inhibits the transportation of a precious metal or precious metal oxide from a conduit or vessel of a glass manufacturing apparatus into molten glass.

As used herein, the term “molten glass” refers to a glass composition that is at or above its liquidous temperature (the temperature above which no crystalline phase can coexist in equilibrium with the glass).

As used herein, the term “free surface of the molten glass” refers to an area where molten glass contacts an atmosphere above the molten glass.

As used herein the term “conduit” refers to a conduit or vessel of a glass manufacturing apparatus that is configured to flow molten glass therethrough. Non-limiting exemplary conduits include mixing vessel 36, fining vessel 34, delivery vessel 40, and connecting conduits.

As used herein, the term “connecting conduit” refers to a conduit used to connect components of a glass manufacturing apparatus and configured to flow molten glass therethrough. Non-limiting exemplary connecting conduits disclosed herein include first connecting conduit 32, second connecting conduit 38, and third connecting conduit 46.

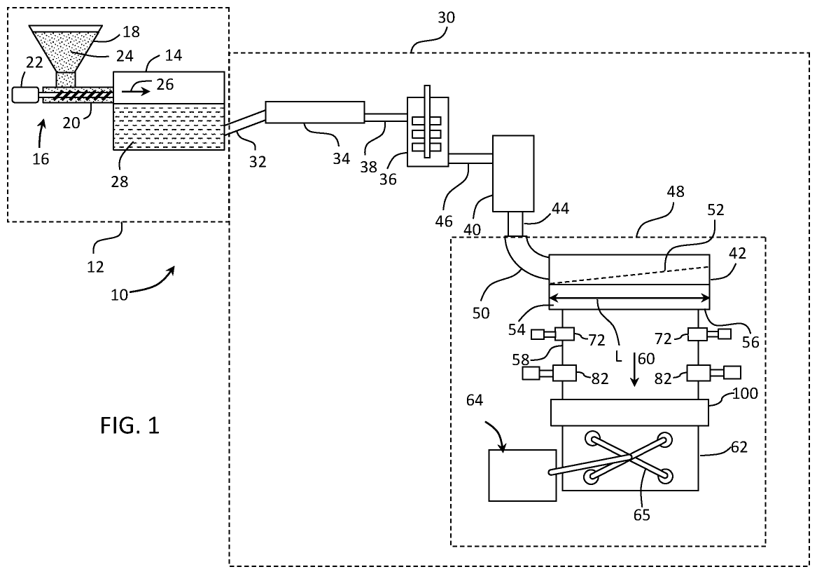

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 includes one or more additional components, such as heating elements (as will be described in more detail herein) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw batch materials 24 that can be fed into melting vessel 14 of glass melting furnace 12, as indicated by arrow 26. Raw batch materials 24 typically comprise one or more glass forming metal oxides and one or more modifying agents. In some examples, raw material delivery device 20 can be powered by motor 22 such that raw material delivery device 20 delivers a predetermined amount of raw batch materials 24 from the storage bin 18 to melting vessel 14. In further examples, motor 22 can power raw material delivery device 20 to introduce raw batch materials 24 at a controlled rate based on a level of molten glass sensed downstream from melting vessel 14. Raw batch materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 100% to about 60% by weight platinum and about 0% to about 40% by weight rhodium. However, other suitable metals can include molybdenum, rhenium, tantalum, titanium, tungsten and alloys thereof. Oxide Dispersion Strengthened (ODS) precious metal alloys are also possible.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw batch materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

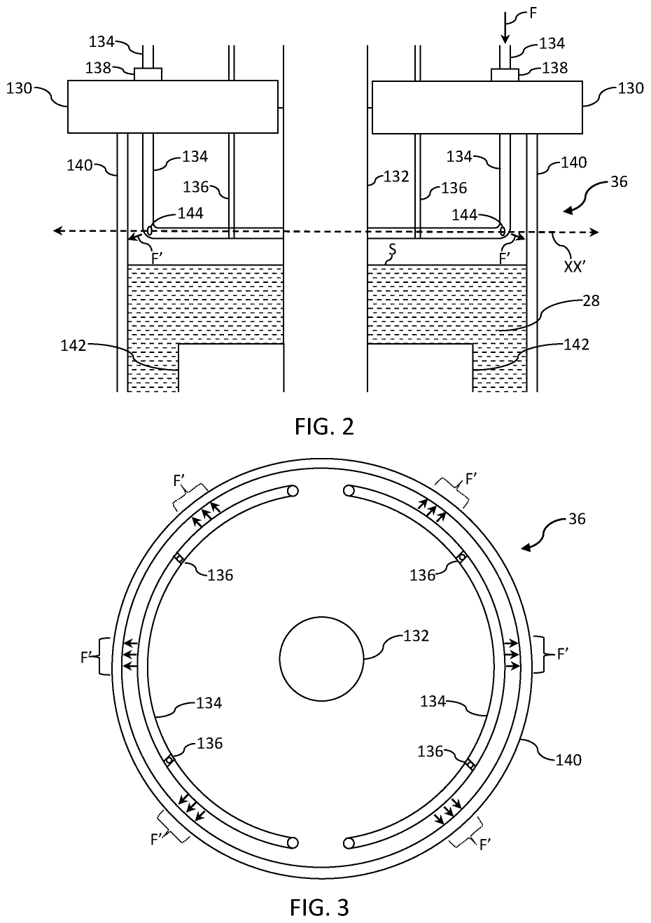

FIG. 2 shows a schematic side cutaway view of a portion of an example mixing vessel 36 in accordance with embodiments disclosed herein. Mixing vessel 36 is configured to enclose molten glass 28 and includes wall 140 that circumferentially surrounds molten glass 28. Mixing vessel also includes removable cover 130 that is configured to be positioned above molten glass 28. In addition, mixing vessel 36 includes rotatable center shaft 132 from which stirring blades 142 extend. Removable cover 130 is configured to allow rotatable center shaft 132 to extend therethrough and may, for example, comprise two approximately semi-circular segments that extend in clamshell fashion around rotatable center shaft 132.

As shown in FIG. 2, channel 134 is positioned such that it extends inside mixing vessel 36 such that a portion of the channel 134 is generally parallel to the free surface S of the molten glass 28 (i.e., a portion of channel 134 extends horizontally). Channel 134 can be secured in mixing vessel 36 with support structures 136, such as wires, as well as with clamping structures 138, such as nuts, which can be loosened or tightened, allowing adjustment of position of channel 134 within mixing vessel 36 (e.g., to move channel 134 to a relatively higher or lower position within mixing vessel 36). Channel 134 is configured to flow a defect inhibiting fluid therethrough and comprises orifices 144 that are proximate to free surface S of the molten glass 28. Orifices 144 are located in the portion of channel 134 that is generally parallel to the free surface S of the molten glass 28.

The defect inhibiting fluid flows into channel 134 from fluid source (not shown) as indicated by arrow F and flow out of channel 134 through orifices 144 as indicated by arrows F′. As shown in FIG. 2, orifices 144 are configured to flow the defect inhibiting fluid toward wall 140 of mixing vessel 36. As shown in FIG. 2, defect inhibiting fluid flows radially outward and slightly downward toward wall 140 of mixing vessel 36 although embodiments herein include those in which defect inhibiting fluid flows radially outward and slightly upward toward wall 140 of mixing vessel 36 and/or directly radially outward (i.e., neither upward or downward) toward wall 140 of mixing vessel 36.

FIG. 3 shows a schematic top cutaway view along line XX′ of the example mixing vessel 36 of FIG. 2. As shown in FIG. 3, two channels 134 are positioned inside mixing vessel 36, each channel 134 comprising a generally semicircular portion (the generally semicircular portion being the portion that is generally parallel to the free surface S of the molten glass as is shown in FIG. 2) that is circumferentially surrounded by wall 140 of mixing vessel 36. Each channel 134 is configured to flow defect inhibiting fluid radially outward toward wall 140 of mixing vessel 36 through a plurality of orifices (not shown in FIG. 3) as indicated by arrows F′.

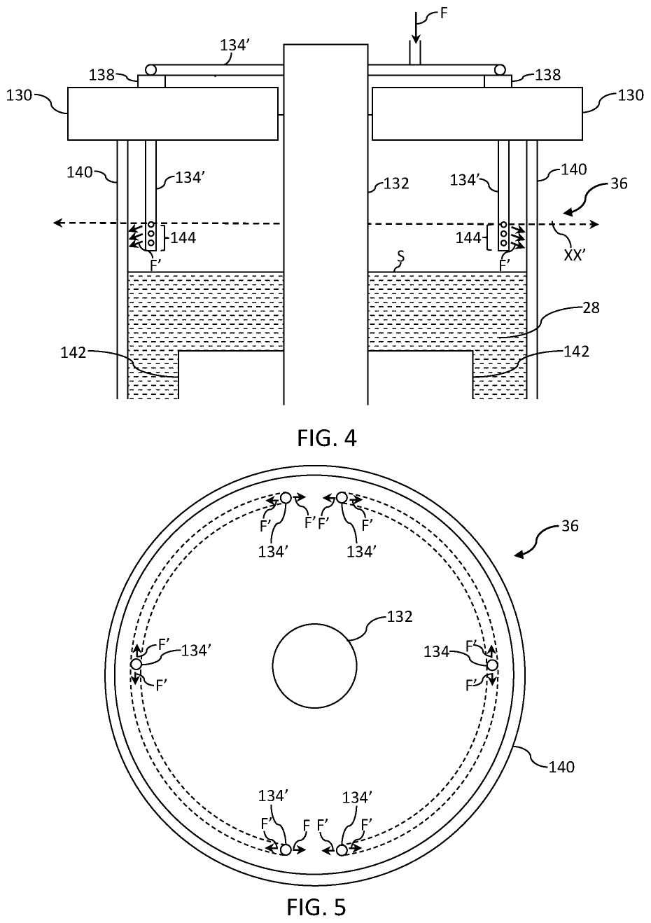

FIG. 4 shows a schematic side cutaway view of a portion of an example mixing vessel 36 in accordance with embodiments disclosed herein. As with the mixing vessel 36 shown in FIG. 2, mixing vessel 36 is configured to enclose molten glass 28 and includes wall 140 that circumferentially surrounds molten glass 28. Mixing vessel also includes removable cover 130 that is configured to be positioned above molten glass 28. In addition, mixing vessel 36 includes rotatable center shaft 132 from which stirring blades 142 extend. Removable cover 130 is configured to allow rotatable center shaft 132 to extend therethrough and may, for example, comprise two approximately semi-circular segments that extend in clamshell fashion around rotatable center shaft 132.

As shown in FIG. 4, channel 134′ is positioned such that a portion of it extends above removable cover 130 and other portions of it extend inside mixing vessel 36 such that such portions of the channel 134′ extending inside mixing vessel 36 are generally perpendicular to the free surface S of the molten glass 28 (i.e., portions of channel 134′ extend vertically). Channel 134′ can be secured in mixing vessel 36 with clamping structures 138, such as nuts, which can be loosened or tightened, allowing adjustment of position of channel 134′ within mixing vessel 36 (e.g., to move channel 134′ to a relatively higher or lower position within mixing vessel 36). Channel 134′ is configured to flow a defect inhibiting fluid therethrough and comprises orifices 144 that are proximate to free surface S of the molten glass 28. Orifices 144 are located in the portions of channel 134′ that are generally perpendicular to the free surface S of the molten glass 28. The defect inhibiting fluid flows into channel 134′ from fluid source (not shown) as indicated by arrow F and flow out of channel 134′ through orifices 144 as indicated by arrows F′.

FIG. 5 shows a schematic top cutaway view along line XX′ of the example mixing vessel 36 of FIG. 4. As shown in FIG. 5, two channels 134′ are positioned such that a generally semicircular portion of each channel extends above removable cover 130 and other portions of channels 134′ extend vertically inside mixing vessel 36 (the portions extending vertically being the portions that are generally perpendicular to the free surface S of the molten glass as is shown in FIG. 4). Each channel 134′ is configured to flow defect inhibiting fluid in a direction that is generally parallel to wall 140 of mixing vessel 36 through a plurality of orifices (not shown in FIG. 5) as indicated by arrows F′.

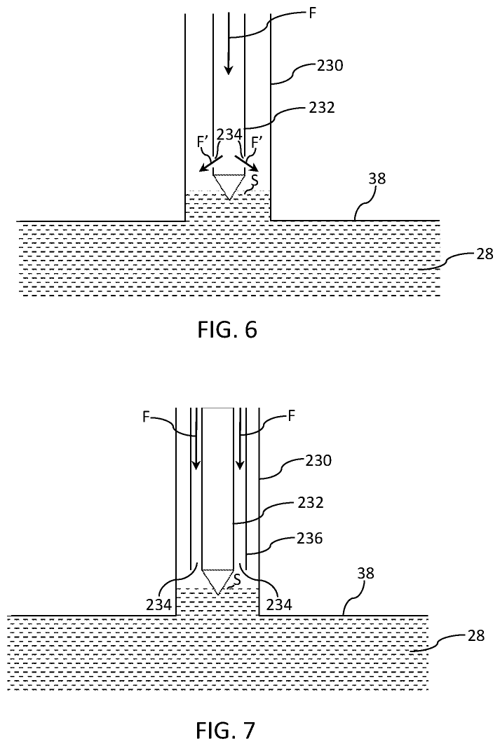

FIG. 6 shows a schematic side cutaway view of a portion of an example conduit in accordance with embodiments disclosed herein. While FIG. 6 shows conduit as second connecting conduit 38, FIG. 6 is also applicable to other conduits disclosed herein, such as first connecting conduit 32 and third connecting conduit 46. Second connecting conduit 38 is configured to enclose molten glass 28 and includes appendage 230 extending radially away from the main body of second connecting conduit 38. Appendage 230 circumferentially surrounds condition measuring device 232 (e.g., level probe, temperature probe, etc.), the tip of which extends into molten glass 28. Condition measuring device 232 acts as a channel that is configured to flow a defect inhibiting fluid therethrough. Specifically, defect inhibiting fluid flows into condition measuring device 232 from fluid source (not shown) as indicated by arrow F and flows out of condition measuring device 232 through orifices 234 as indicated by arrows F′. As can be seen in FIG. 6, orifices 234 are proximate the free surface S of the molten glass 28.

FIG. 7 shows a schematic side cutaway view of a portion of an example conduit in accordance with embodiments disclosed herein. As with FIG. 6, FIG. 7 shows conduit as second connecting conduit 38 while also being applicable to other conduits disclosed herein, such as first connecting conduit 32 and third connecting conduit 46. As with FIG. 6, second connecting conduit 38 is configured to enclose molten glass 28 and includes appendage 230 extending radially away from the main body of second connecting conduit 38. Appendage 230 circumferentially surrounds condition measuring device 232 (e.g., level probe, temperature probe, etc.), the tip of which extends into molten glass 28. Sheath 236 circumferentially surrounds condition measuring device 232 and is circumferentially surrounded by appendage 230. Sheath 236 acts as a channel that is configured to flow a defect inhibiting fluid therethrough. Specifically, defect inhibiting fluid flows into sheath 236 from fluid source (not shown) as indicated by arrow F and flows out of sheath 236 through orifices 234. As can be seen in FIG. 7, orifices 234 are proximate the free surface S of the molten glass 28.

In certain exemplary embodiments, such as the embodiments illustrated in FIGS. 2-7, one or more orifices configured to be positioned proximate a free surface of the molten glass 28 and to flow the defect inhibiting fluid out of the channel (e.g., channel 134, 134′, etc.). For example, one or more orifices can be positioned from about 5 millimeters to about 75 millimeters, such as from about 10 millimeters to about 50 millimeters, of the free surface of the molten glass 28. In addition, in certain exemplary embodiments, one or more orifices can be positioned from about 5 millimeters to about 75 millimeters, such as from about 10 millimeters to about 50 millimeters, of the wall 140.

In certain exemplary embodiments, such as the embodiments illustrated in FIGS. 2-7, channels can be comprised of the same or similar materials as the vessel (e.g., mixing vessel 36) or the conduit (e.g., second connecting conduit 38). For example, in certain exemplary embodiments, channel 134, channel 134′, condition measuring device 232, and/or sheath 236 may comprise a precious metal or precious metal alloy. Exemplary precious metals include platinum group metals selected from the group of metals consisting of platinum, iridium, rhodium, osmium, ruthenium and palladium, or alloys thereof. For example, channels may comprise a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

The defect inhibiting fluid inhibits the transportation of a precious metal or precious metal oxide from the vessel (e.g., mixing vessel 36) or the conduit (e.g., second connecting conduit 38) into molten glass 28. For example, where the vessel or conduit comprises a platinum/rhodium alloy an oxygen rich atmosphere, the following redox reaction can occur:

Pt·Rh+O₂→Pt·RhO₂

Such reaction can result in the presence of undesirable amounts of platinum and/or rhodium oxides in the molten glass 28. This reaction allows the formation of precious metal gas that is now available as a source for defect formation through the reverse reaction:

Pt·RhO₂→O₂+Pt·Rh

This reverse step can also involve other reactions, such as the redox reaction of a multivalent element (SnO/SnO₂, FeO/Fe₂O₃, etc.). Flowing a defect inhibiting fluid proximate a free surface of the molten glass 28 as disclosed herein can inhibit such reactions.

Exemplary defect inhibiting fluids include, but are not limited to, nitrogen, argon, helium, neon, krypton, xenon, radon, hydrogen, chlorine, or mixtures thereof.

In certain exemplary embodiments, the temperature of the defect inhibiting fluid can be at or near the temperature of the molten glass 28. For example, the temperature of the defect inhibiting fluid can be at least about 1200° C., such as at least about 1300° C., and further such as at least about 1400° C., and yet further such as at least about 1500° C., including from about 1200° C. to about 1700° C., such as from about 1300° C. to about 1600° C.

In certain exemplary embodiments, the flowrate of the defect inhibiting fluid can range from about 0.1 to about 100 Standard Liters Per Minute (SLPM), such as from about 5 SLPM to about 50 SLPM.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. A glass manufacturing apparatus comprising:
a conduit comprising a precious metal or precious metal alloy and configured to flow molten glass therethrough; and
a channel positioned inside or proximate the conduit and configured to flow a defect inhibiting fluid therethrough, the channel comprising at least one orifice configured to be positioned proximate a free surface of the molten glass to flow the defect inhibiting fluid out of the channel.

2. The apparatus of claim 1, wherein the at least one orifice is configured to be positioned from about 5 millimeters to about 75 millimeters of the free surface of the molten glass.

3. The apparatus of claim 1, wherein the conduit comprises a vessel that circumferentially surrounds the channel.

4. The apparatus of claim 3, wherein the vessel comprises a mixing vessel.

5. The apparatus of claim 1, wherein the conduit comprises a connecting conduit.

6. The apparatus of claim 1, wherein the defect inhibiting fluid is selected from at least one of nitrogen, argon, helium, neon, krypton, xenon, radon, hydrogen, chlorine, or mixtures thereof.

7. The apparatus of claim 3, wherein the at least one orifice is configured to flow the defect inhibiting fluid toward a wall of the vessel.

8. The apparatus of claim 3, wherein the at least one orifice is configured to flow the defect inhibiting fluid in a direction that is generally parallel to a wall of the vessel.

9. The apparatus of claim 7, wherein the orifice is configured to be positioned along a portion of the channel that is generally parallel to the free surface of the molten glass.

10. The apparatus of claim 8, wherein the orifice is configured to be positioned along a portion of the channel that is generally perpendicular to the free surface of the molten glass.

11. A method of manufacturing a glass article comprising;
transporting molten glass through a conduit comprising a precious metal or precious metal alloy; and
flowing a defect inhibiting fluid out of at least one orifice of a channel positioned inside or proximate the conduit, the at least one orifice positioned proximate a free surface of the molten glass.

12. The method of claim 11, wherein the at least one orifice is positioned from about 5 millimeters to about 75 millimeters of the free surface of the molten glass.

13. The method of claim 11, wherein the conduit comprises a vessel that circumferentially surrounds the channel.

14. The method of claim 13, wherein the vessel comprises a mixing vessel.

15. The method of claim 11, wherein the conduit comprises a connecting conduit.

16. The method of claim 11, wherein the defect inhibiting fluid is selected from at least one of nitrogen, argon, helium, neon, krypton, xenon, radon, hydrogen, chlorine, or mixtures thereof

17. The method of claim 13, wherein the at least one orifice flows the defect inhibiting fluid toward a wall of the vessel.

18. The method of claim 13, wherein the at least one orifice flows the defect inhibiting fluid in a direction that is generally parallel to a wall of the vessel.

19. The method of claim 17, wherein the orifice is positioned along a portion of the channel that is generally parallel to the free surface of the molten glass.

20. The method of claim 18, wherein the orifice is positioned along a portion of the channel that is generally perpendicular to the free surface of the molten glass.

21. A glass article made by the method of claim 11.

22. An electronic device comprising the glass article of claim 21.
